(19) United States
(12) Patent Application Publication
(10) Pub. No.: US 2015/0102127 A1
(43) Pub. Date: Apr. 16, 2015

(54) SPRAY ASSEMBLY FOR A DISHWASHER APPLIANCE

(71) Applicant: General Electric Company, Schenectady, NY (US)

(72) Inventors: Daniel Jason Bentley, Louisville, KY (US); Kyle Edward Durham, Louisville, KY (US)

(73) Assignee: General Electric Company, Schenectady, NY (US)

(21) Appl. No.: 14/050,605

(22) Filed: Oct. 10, 2013

(51) Int. Cl. A47L 15/23; B05B 3/10; B05B 3/08

(52) U.S. Cl. CPC A47L 15/23; B05B 3/08; B05B 3/10
USPC 239/222

(57) ABSTRACT

The present subject matter provides a spray assembly for a dishwasher appliance. The spray assembly includes a housing and an impeller disposed within a chamber of the housing such that the impeller is rotatable about an axis of rotation within the chamber of the housing. The impeller includes a plurality of conduits for directing flows of wash fluid. Each conduit of the plurality of conduits can have a different size and/or shape in order to provide suitable wash fluid coverage within the dishwasher appliance.

### FIELD OF THE INVENTION

The present subject matter relates generally to dishwasher appliances and spray assemblies for dishwasher appliances.

### BACKGROUND OF THE INVENTION

Dishwasher appliances generally include a tub that defines a wash compartment. Rack assemblies are mounted within the wash compartment and are configured for receipt of articles for washing. Spray assemblies are also mounted within the wash compartment and can apply wash fluid to articles within the rack assemblies during operation of the dishwasher appliance. The spray assemblies can include a lower spray assembly directly or indirectly mounted to the tub at a bottom of the wash compartment, a mid-level spray assembly mounted to one of the rack assemblies, and an upper spray assembly directly or indirectly mounted to the tub at a top of the wash compartment.

The upper spray assembly preferably has a small vertical height in order to permit large items to be placed in the top rack assembly. In certain dishwasher appliances, the upper spray assembly is a static nozzle mounted to the tub. The static nozzle defines a plurality of outlets directed in various directions. During dishwasher appliance operations, the static nozzle remains stationary such that flows of wash fluid out of the static nozzle are directed in the same direction throughout the dishwasher appliance's operation. Static nozzles can have a small vertical height. However, static nozzles have certain drawbacks. In particular, areas outside of the static nozzle's flow paths can receive little or no wash fluid during operation of the dishwasher appliance.

Accordingly, a spray assembly for a dishwasher appliance with features for directing wash fluid towards a large portion of a rack assembly of the dishwasher appliance would be useful. In particular, a spray assembly for a dishwasher appliance with features for directing wash fluid towards a large portion of a rack assembly of the dishwasher appliance while also having a small vertical height would be useful.

### BRIEF DESCRIPTION OF THE INVENTION

The present subject matter provides a spray assembly for a dishwasher appliance. The spray assembly includes a housing and an impeller disposed within a chamber of the housing such that the impeller is rotatable about an axis of rotation within the chamber of the housing. The impeller includes a plurality of conduits for directing flows of wash fluid. Each conduit of the plurality of conduits can have a different size and/or shape in order to provide suitable wash fluid coverage within the dishwasher appliance. Additional aspects and advantages of the invention will be set forth in part in the following description, or may be apparent from the description, or may be learned through practice of the invention.

In a first exemplary embodiment, a spray assembly for a dishwasher appliance is provided. The spray assembly defines an axial direction, a radial direction and a circumferential direction. The spray assembly includes a housing having an annular sidewall and a base plate. The annular sidewall and the base plate are mounted to each other and define a chamber. The annular sidewall also defines a plurality of openings. The openings of the plurality of openings are spaced apart from each other along the circumferential direction on the annular sidewall. An impeller is disposed within the chamber of the housing. The impeller is rotatable about an axis of rotation within the chamber of the housing. The impeller has a central portion and an outer portion that are spaced apart from each other along the radial direction. The impeller defines a plurality of conduits. Each conduit of the plurality of conduits extends between an entrance and an exit. The entrance of each conduit of the plurality of conduits is positioned adjacent the central portion of the impeller. The exit of each conduit of the plurality of conduits is positioned at the outer portion of the impeller. A first exit of the plurality of conduits has a first height along the axial direction. A second exit of the plurality of conduits has a second height along the axial direction. The first height is different than the second height.

In a second exemplary embodiment, a spray assembly for a dishwasher appliance is provided. The spray assembly defines an axial direction, a radial direction and a circumferential direction. The spray assembly includes a housing having an annular sidewall and a base plate. The annular sidewall and the base plate are mounted to each other and define a chamber. The annular sidewall also defines a plurality of openings. The openings of the plurality of openings are spaced apart from each other along the circumferential direction on the annular sidewall. An impeller is disposed within the chamber of the housing. The impeller is rotatable about an axis of rotation within the chamber of the housing. The impeller has a central portion and an outer portion that are spaced apart from each other along the radial direction. The impeller defines a plurality of conduits. Each conduit of the plurality of conduits extends between an entrance and an exit. The entrance of each conduit of the plurality of conduits is positioned adjacent the central portion of the impeller. The exit of each conduit of the plurality of conduits is positioned at the outer portion of the impeller. A first exit of the plurality of conduits has a first width along the circumferential direction. A second exit of the plurality of conduits has a second width along the circumferential direction. The first width is different than the second width.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a dishwasher appliance according to an exemplary embodiment of the present subject matter.

FIG. 2 provides a side, elevation view of the exemplary dishwasher appliance of FIG. 1 with portions of a cabinet of the exemplary dishwasher appliance removed in order to show certain internal components of the exemplary dishwasher appliance.

FIG. 3 provides a perspective view of a spray assembly for a dishwasher appliance according to an exemplary embodiment of the present subject matter.

FIG. 4 provides a top, plan view of the exemplary spray assembly of FIG. 3.

FIG. 5 provides a side, elevation view of the exemplary spray assembly of FIG. 3.

FIG. 6 provides a side, section view of the exemplary spray assembly of FIG. 3.

FIG. 7 provides a perspective view of a housing of the exemplary spray assembly of FIG. 3.

FIG. 8 provides a perspective view of an impeller of the exemplary spray assembly of FIG. 3.

FIG. 9 provides a top, plan view of the exemplary impeller of FIG. 8.

FIG. 10 provides a side, elevation view of the exemplary impeller of FIG. 8.

FIG. 11 provides a bottom, plan view of the exemplary impeller of FIG. 8.

FIG. 12 provides a side, section view of a spray assembly for a dishwasher appliance according to another exemplary embodiment of the present subject matter

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

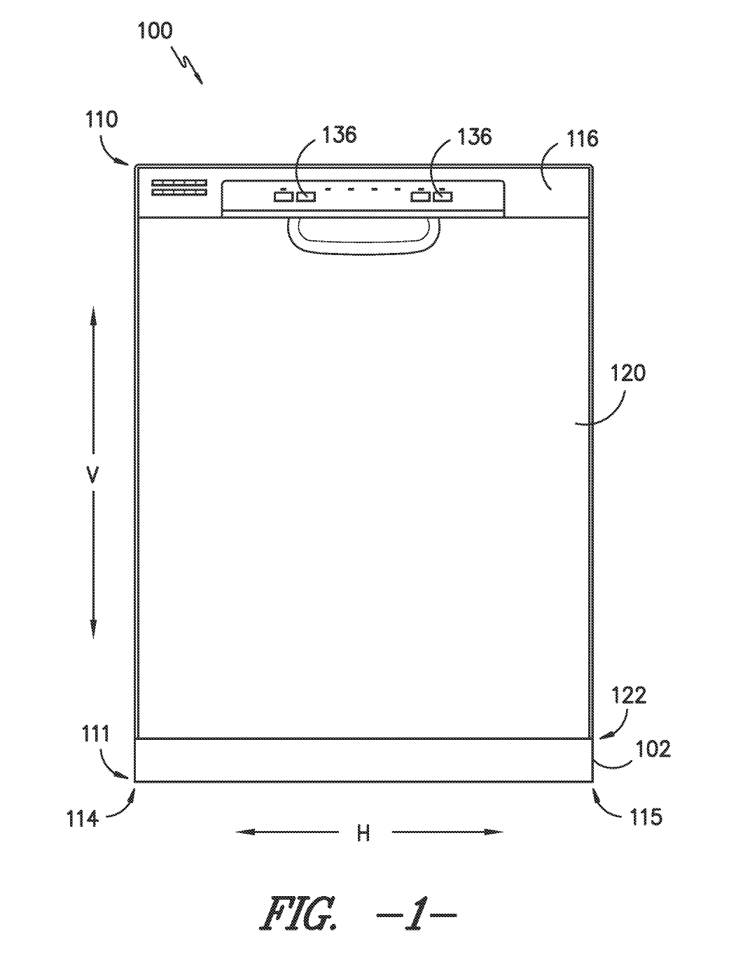

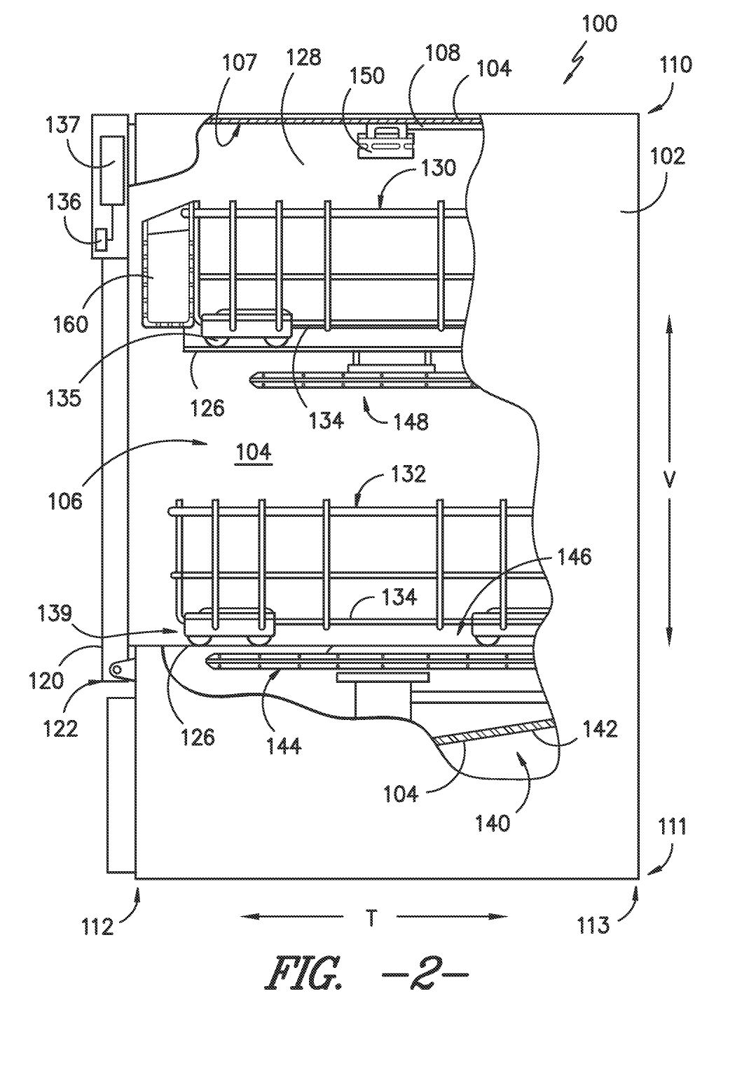

FIGS. 1 and 2 depict a dishwasher appliance 100 according to an exemplary embodiment of the present subject matter. Dishwasher appliance 100 includes a cabinet 102 having a tub 104 therein that defines a wash compartment 106. In particular, tub 104 includes a top wall 107 that assists in defining wash compartment 106. Tub 104 also includes a door 120 hinged at its bottom 122 for movement between a normally closed configuration (shown in FIGS. 1 and 2) in which wash compartment 106 is sealed shut, e.g., for washing operation, and an open configuration, e.g., for loading and unloading of articles from dishwasher appliance 100.

Dishwasher appliance 100 defines a vertical direction V, a lateral direction L and a transverse direction T. The vertical direction V, the lateral direction L and the transverse direction T are mutually perpendicular and form an orthogonal direction system. As may be seen in FIG. 1, dishwasher appliance 100 extends between a top portion 110 and a bottom portion 111 along the vertical direction V and also extends between a first side portion 114 and a second side portion 115 along the lateral direction L. As may be seen in FIG. 2, dishwasher appliance 100 also extends between a front portion 112 and a back portion 113 along the transverse direction T.

Guide rails 126 are mounted on tub side walls 128 and accommodate upper and lower roller-equipped rack assemblies 130 and 132. Each of the upper and lower rack assemblies 130 and 132 is fabricated from lattice structures that include a plurality of elongated members 134. Each rack of the upper and lower rack assemblies 130 and 132 is adapted for movement between an extended loading position (not shown) in which the rack is substantially positioned outside the wash compartment 106, and a retracted position (shown in FIGS. 1 and 2) in which the rack is located inside the wash compartment 106.

A silverware basket 160 is removably mounted to upper rack assembly 130. However, silverware basket 160 may also be selectively attached to other portions of dishwasher appliance 100, e.g., lower rack 132 or door 120. Silverware rack 160 is configured for receipt of silverware, utensils, and the like, that are too small to be accommodated by the upper and lower rack assemblies 130 and 132.

The dishwasher appliance 100 further includes a lower spray assembly 144 that is mounted within a lower region 146 of the wash compartment 106 and above a tub sump portion 142 so as to be in relatively close proximity to the lower rack 132. A mid-level spray assembly 148 is located in an upper region of the wash compartment 106 and may be located in close proximity to upper rack 130. Additionally, an upper spray assembly 150 is located above the upper rack 130 and mounted to top wall 107 of tub 104.

The lower and mid-level spray assemblies 144 and 148 and the upper spray assembly 150 are fed by a fluid circulation assembly (not shown) for circulating water and wash fluid (e.g., detergent, water, and/or rinse aid) in the tub 104. The fluid circulation assembly may be located in a machinery compartment 140 located below the bottom sump portion 142 of the tub 104, as generally recognized in the art. The fluid circulation assembly also includes circulation piping 108 that directs liquid water and/or wash fluid to upper spray assembly 150.

Each spray assembly includes an arrangement of discharge ports or orifices for directing washing liquid onto dishes or other articles located in the upper and lower racks 130, 132 and silverware basket 160. The lower and mid-level spray assemblies 144 and 148 may be rotatably mounted in wash compartment 106. Accordingly, the arrangement of the discharge ports in at least the lower spray assembly 144 may provide a rotational force by virtue of washing fluid flowing through the discharge ports. The resultant rotation of the lower spray assembly 144 can provide coverage of dishes and other dishwasher contents with a washing spray.

The dishwasher appliance 100 is further equipped with a controller 137 to regulate operation of the dishwasher appliance 100. The controller may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor.

The controller 137 may be positioned in a variety of locations throughout dishwasher appliance 100. In the illustrated embodiment, the controller 137 may be located within a control panel 116 of door 120 as shown. In such an embodiment, input/output (“I/O”) signals may be routed between the control system and various operational components of dishwasher appliance 100 along wiring harnesses that may be routed through the bottom 122 of door 120. Typically, the controller 137 includes a user interface panel 136 through which a user may select various operational features and modes and monitor progress of the dishwasher appliance 100. In one embodiment, the user interface 136 may represent a general purpose I/O (“GPIO”) device or functional block. In one embodiment, the user interface 136 may include input components, such as one or more of a variety of electrical, mechanical or electro-mechanical input devices including rotary dials, push buttons, and touch pads. The user interface 136 may include a display component, such as a digital or analog display device designed to provide operational feedback to a user. The user interface 136 may be in communication with the controller 137 via one or more signal lines or shared communication busses.

It should be appreciated that the present subject matter is not limited to any particular style, model, or other configuration of dishwasher appliance and that dishwasher appliance 100 depicted in FIGS. 1 and 2 is provided for illustrative purposes only. For example, the present subject matter may be used in dishwasher appliances having other rack configurations.

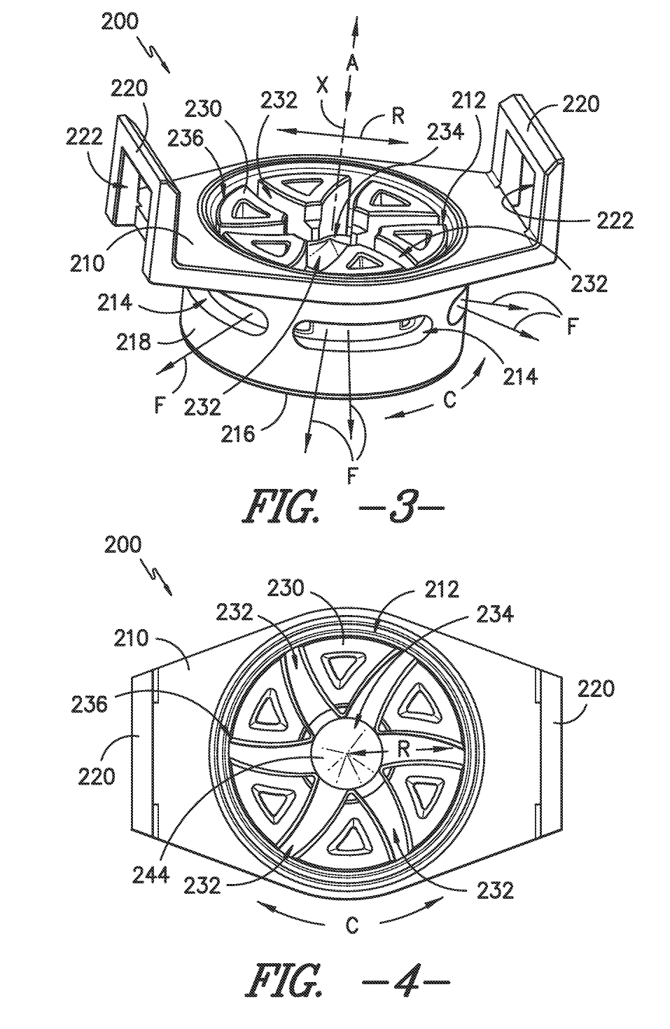

FIG. 3 provides a perspective view of a spray assembly 200 for a dishwasher appliance according to an exemplary embodiment of the present subject matter. FIG. 4 provides a top, plan view of spray assembly 200. Spray assembly 200 can be used in any suitable dishwasher appliance. For example, spray assembly 200 may be used in dishwasher appliance 100 as upper spray assembly 150 (FIG. 2). Spray assembly 200 defines an axial direction A, a radial direction R and a circumferential direction C.

As may be seen in FIGS. 3 and 4, spray assembly 200 includes a hub or housing 210 and an impeller 230. Housing 210 defines a chamber 212 and a plurality of openings 214. Openings 214 of housing 210 are spaced apart from each other, e.g., along the circumferential direction C, on housing 210. Impeller 230 is disposed within chamber 212 of housing 210. In particular, impeller 230 is mounted within chamber 212 of housing 210 such that impeller 230 is rotatable about an axis of rotation X within chamber 212 of housing 210. The axis of rotation X may be substantially parallel to the axial direction A and/or substantially perpendicular to the radial direction R and circumferential direction C.

Housing 210 also includes brackets 220. Brackets 220 define slots 222. Brackets 220 and slots 222 can assist with mounting housing 210 and spray assembly 200 within dishwasher appliance 100. For example, brackets 220 may be positioned against circulation piping 108 of dishwasher appliance 100 such that a portion of circulation piping 108 is received within slots 222. In such a manner, housing 210 and spray assembly 200 may be snap fit onto circulation piping 108 in order to act as upper spray assembly 150 of dishwasher appliance 100. Housing 210 and spray assembly 200 may be mounted in dishwasher appliance 100 using any other suitable method or mechanism in alternative exemplary embodiments, e.g., using fasteners, adhesives, ultrasonic welding, etc.

Impeller 230 has a central portion 234 and an outer portion 236. Central portion 234 of impeller 230 and outer portion 236 of impeller 230 are spaced apart from each other, e.g., along the radial direction R. Thus, impeller 230 extends between central portion 234 of impeller 230 and outer portion 236 of impeller 230, e.g., along the radial direction R.

Impeller 230 defines a plurality of conduits 232. Conduits 232 are configured for directing flows of liquid (shown with arrows F) from central portion 234 of impeller 230 to outer portion 236 of impeller 230. Outer portion 236 of impeller 230 is positioned at or adjacent openings 214 of housing 210. Thus, flows of liquid F can exit chamber 212 of housing 210 through openings 214 of housing 210 after flowing through conduits 232 of impeller 230. As discussed in greater detail below, conduits 232 are shaped and sized in order to facilitate rotation of impeller 230 about the axis of rotation X, e.g., during operation of dishwasher appliance 100. Conduits 232 are also shaped and sized in order to direct flows of liquid F in a variety of directions in order to facilitate uniform and/or widespread application of wash fluid by spray assembly 200 during operation of dishwasher appliance 100.

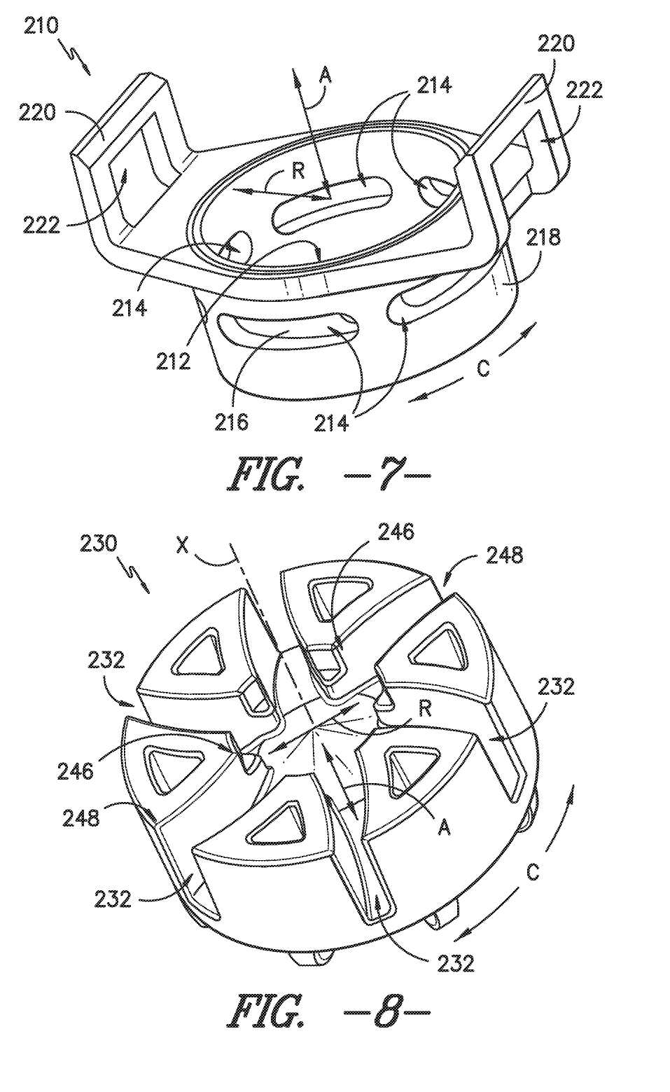

Impeller 230 can include any suitable number of conduits 232. For example, as shown in FIGS. 3 and 4, impeller 230 may include six conduits. In alternative exemplary embodiments, impeller 230 may include four, five, seven, eight or more conduits. Similarly, housing 210 can include any suitable number of openings 214. FIG. 7 provides a perspective view of housing 210 of spray assembly 200. As may be seen in FIG. 7, housing 210 may include five outlets. In alternative exemplary embodiments, housing 210 may include three, four, six, seven or more outlets. Further, a number of conduits 232 of impeller 230 can be greater than a number of openings 214 of housing 210. For example, conduits 232 of impeller 230 may include at least six conduits, and openings 214 of housing 210 may include at least five openings. In alternative exemplary embodiments, the number of conduits 232 of impeller 230 can be less than the number of openings 214 of housing 210. For example, conduits 232 of impeller 230 may include at least three conduits, and openings 214 of housing 210 may include at least four openings.

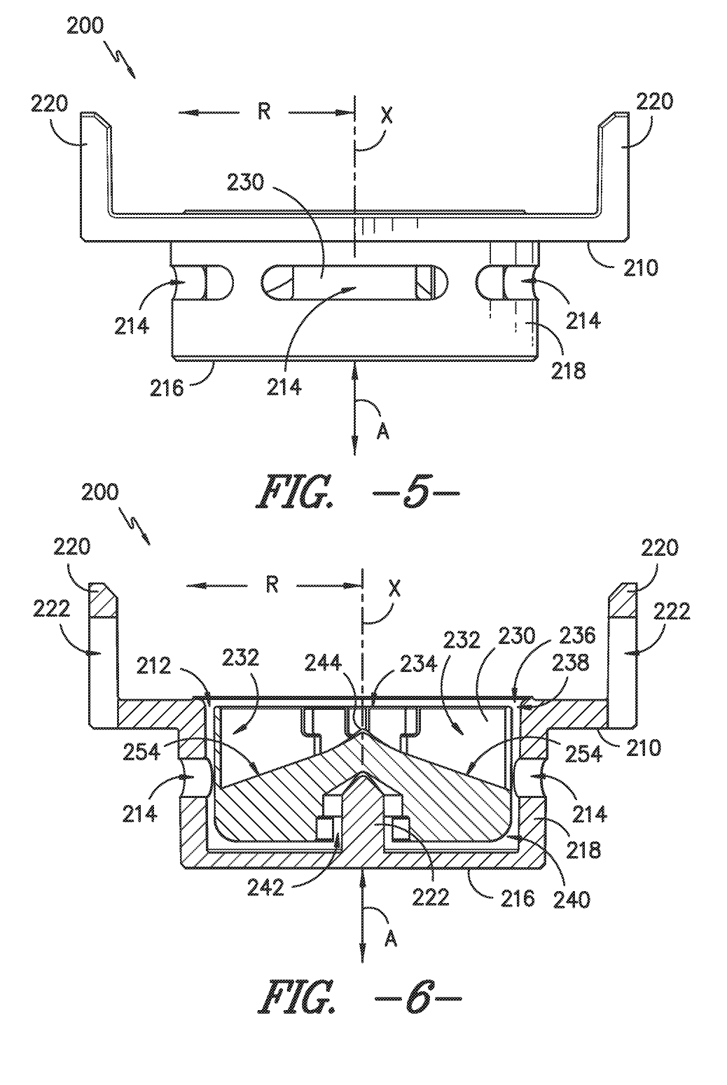

FIG. 5 provides a side, elevation view of spray assembly 200. FIG. 6 provides a side, section view of spray assembly 200. As may be seen in FIGS. 5 and 6, housing 210 has a base plate 216 and an annular sidewall 218. Annular sidewall 218 and base plate 216 are mounted to each other and define chamber 212 of housing 210 therein. Annular sidewall 218 also defines openings 214 of housing 210, e.g., such that openings 214 of housing 210 are spaced apart from each other along the circumferential direction C on annular sidewall 218. Outer portion 236 of impeller 230 is positioned at annular sidewall 218 of housing 210 such that flows of liquid F (FIG. 3) are directed through conduits 232 of impeller 230 and exit chamber 212 of housing 210 through openings 214 of housing 210.

Impeller 230 also extends between a top portion 238 and a bottom portion 240, e.g., along the axial direction A. Thus, top and bottom portions 238 and 240 of impeller 230 are spaced apart from each other, e.g., along the axial direction A. Conduits 232 of impeller 230 are positioned at or adjacent top portion 238 of impeller 230. Conversely, impeller 230 defines a cavity 242 at bottom portion 240 of impeller 230. Housing 210 has a pivot 222 mounted to base plate 216 of housing 210, e.g., positioned adjacent bottom portion 240 of impeller 230. Pivot 222 of housing 210 is received within cavity 242 of impeller 230, e.g., such that impeller 230 rests on pivot 222 and pivot acts as a pin bearing in order to rotatably mount impeller 230 within chamber 212 of housing 210. In such manner, impeller 230 is spaced apart from base plate 216 and annular sidewall 218 of housing 210 within chamber 212 of housing 210.

Impeller 230 also includes a diverter cone 244 positioned at or proximate central portion 234 of impeller 230. Flows of liquid F (FIG. 3) can enter chamber 212 of housing 210, e.g., from circulation piping 108, such that flows of liquid F are directed along the axial direction A. Flows of liquid F can impact diverter cone 244 during operation of spray assembly 200 such that flows of liquid F are at least partially redirected or deflected by diverter cone 244 along the radial direction R. Diverter cone 244 can slope downwardly from central portion 234 of impeller 230 towards outer portion 236 of impeller 230.

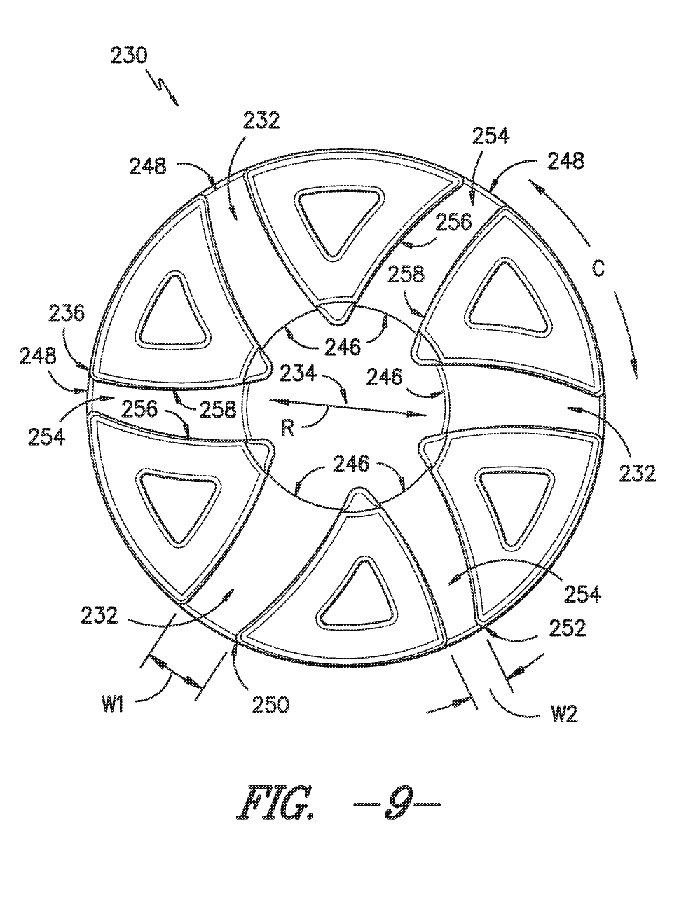

FIG. 8 provides a perspective view of impeller 230. FIG. 9 provides a top, plan view of impeller 230. As may be seen in FIGS. 8 and 9, each conduit of conduits 232 extend between an entrance 246 and an exit 248, e.g., along the radial direction R. Entrance 246 of each conduit of conduits 232 is positioned at or adjacent central portion 234 of impeller 230. Conversely, exit 248 of each conduit of conduits 232 is positioned at or adjacent outer portion 236 of impeller 230.

As discussed above, conduits 232 are shaped and sized in order to facilitate rotation of impeller 230 about the axis of rotation X, e.g., during operation of dishwasher appliance 100. Further, conduits 232 are also shaped and sized in order to direct flows of liquid F (FIG. 3) in a variety of directions in order to facilitate uniform and/or widespread application of wash fluid by spray assembly 200 during operation of dishwasher appliance 100. In particular, various exits 248 of outlets 232 may be shaped and/or sized differently, e.g., in order to facilitate rotation of impeller 230 about the axis of rotation X and/or facilitate uniform application of wash fluid by spray assembly 200.

Turning now to FIG. 9, the sizing and/or shape of exits 248 of outlets 232 are discussed in greater detail. As may be seen in FIG. 9, a first exit 250 of conduits 232 has a first width, W1, e.g., along the circumferential direction C or in a plane that is perpendicular to the radial direction R. Conversely, a second exit 252 of conduits 232 has a second width, W2, e.g., along the circumferential direction C or in a plane that is perpendicular to the radial direction R. The first width W1 is different than the second width W2. Thus, first and second exits 250 and 252 have different widths. In such a manner, respective flows of liquid F (FIG. 3) exiting conduits 232 at first and second exits 250 and 252 can have different widths as well, e.g., thereby encouraging uniform and/or widespread application of liquid during operation of spray assembly 200. Various combinations of widths for exits 248 of conduits 232 are within the scope of the present subject matter. As an example, at least two conduits of conduits 232 may have different widths while at least two other conduits of conduits 232 may have the same widths in certain exemplary embodiments.

Conduits 232 can have any suitable shape or cross-section. For example, each conduit of conduits 232 may define an arcuate shape or cross-section, e.g., in a plane that is perpendicular to the axial direction A, from about entrance 246 to exit 248 of each conduit of conduits 232. As another example, each conduit of conduits 232 may define a rectangular shape or cross-section, e.g., in a plane that is perpendicular to the radial direction R, from about entrance 246 to exit 248 of each conduit of conduits 232.

As may be seen in FIG. 9, each conduit of conduits 232 has a bottom surface 254, a concave surface 256 and a convex surface 258. Bottom surface 254, concave surface 256 and convex surface 258 can define conduits 232 and direct flows of liquid F (FIG. 3) through conduits 232. Further, the curved shape of concave surface 256 and convex surface 258 can facilitate rotation of impeller 230 about the axis of rotation X by directing flows of liquid F. Turning back to FIG. 6, bottom surface 254 of conduits 232 slopes downwardly, e.g., along the axial direction A, from entrance 246 of conduits 232 to exits 248 of conduits 232. Thus, conduits 232 expand or enlarge, e.g., along the radial direction R, from about entrance 246 of conduits 232 to exits 248 of conduits 232.

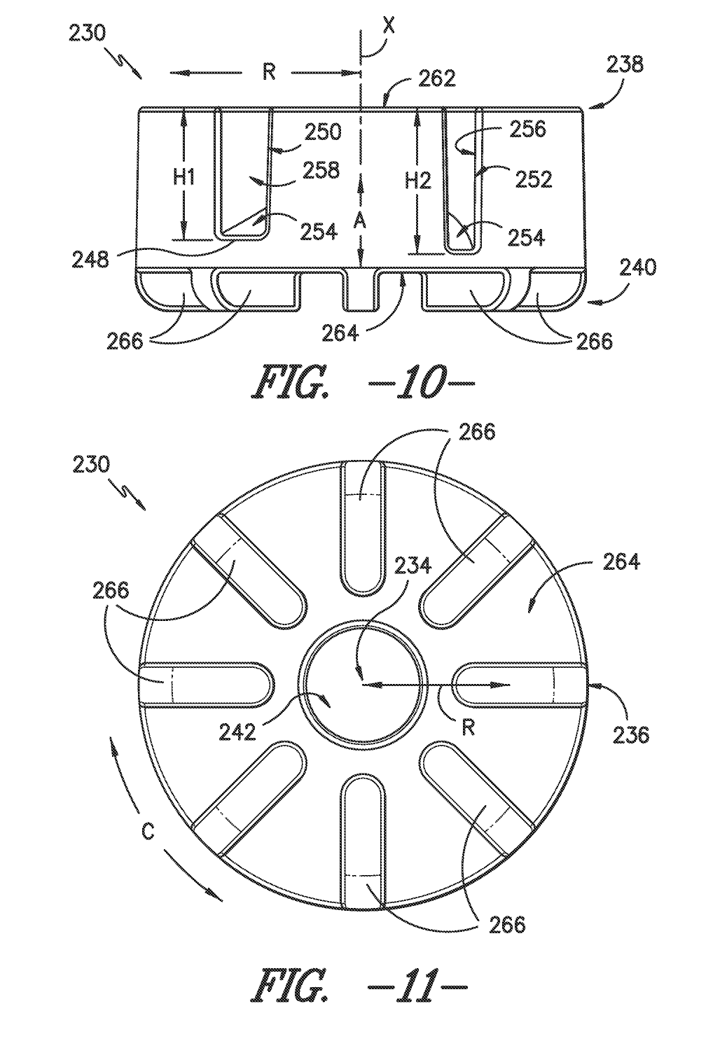

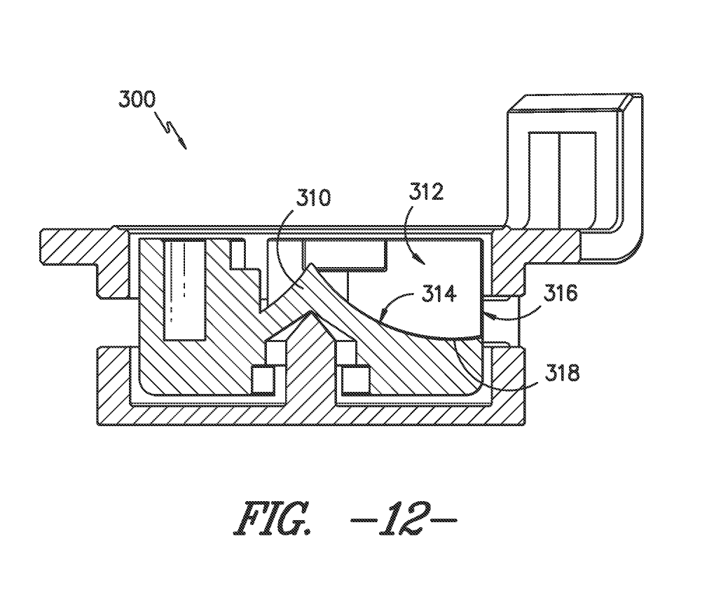

FIG. 10 provides a side, elevation view of impeller 230. FIG. 11 provides a bottom, plan view of impeller 230. As may be seen in FIG. 10, first exit 250 of conduits 232 has a first height, H1, e.g., along the axial direction A. Conversely, second exit 252 of conduits 232 has a second height, H2, e.g., along the axial direction A. The first height H1 is different than the second height H2. Thus, first and second exits 250 and 252 have different heights. In such a manner, respective flows of liquid F (FIG. 3) exiting conduits 232 at first and second exits 250 and 252 can have different heights, e.g., thereby encouraging uniform and/or widespread application of liquid during operation of spray assembly 200. Various combinations of heights for exits 248 of conduits 232 are within the scope of the present subject matter. As an example, at least two conduits of conduits 232 may have different heights while at least two other conduits of conduits 232 may have the same heights in certain exemplary embodiments.

Impeller 230 has a top surface 262 and a bottom surface 264 that are spaced apart from each other, e.g., along the axial direction A. Conduits 232 are positioned adjacent or proximate top surface 262 of impeller 230. As may be seen in FIGS. 10 and 11, impeller 230 has a plurality of blades 266 positioned at bottom surface 264 of impeller 230. Blades 266 extend, e.g., along the axial direction A, from bottom surface 264 of impeller 230. Blades 266 are spaced apart from each other, e.g., along the circumferential direction C. In particular, blades 266 may be uniformly distributed or dispersed along the circumferential direction C on bottom surface 264 of impeller 230. Blades 266 can hinder or dampen rotation of impeller 230 about the axis of rotation X during operation of spray assembly 200. Thus, blades 266 can limit an angular velocity of impeller 230 during rotation of impeller 230 about the axis of rotation X.

Blades 266 can have any suitable shape or cross-section. For example, each blade of blades 266 may define a substantially rectangular shape or cross-section, e.g., in a plane that is perpendicular to the axial direction A. Further, blades 266 may extend linearly along the radial direction R between central and outer portions 234 and 236 of impeller 230.

FIG. 12 provides a side, section view of a spray assembly 300 for a dishwasher appliance according to another exemplary embodiment of the present subject matter. Spray assembly 300 is substantially similar to spray assembly 200 (FIG. 3) and operates and is constructed in a similar manner. Spray assembly 300 can be used in any suitable dishwasher appliance. For example, spray assembly 300 may be used in dishwasher appliance 100 as upper spray assembly 150 (FIG. 2).

As may be seen in FIG. 12, spray assembly 300 includes an impeller 300 that defines a conduit 312. Conduit 312 includes a bottom surface 314. Bottom surface 314 includes a ramp 318, e.g., at an exit 316 of conduit 314. Ramp 318 can assist with dispersing wash fluid during operation of spray assembly 300. For example, wash fluid exiting conduit 314 at exit 316 of conduit 314 can be deflected upwardly due to ramp 318. Other conduits of spray assembly 300 need not include ramp 318. In such a manner, spray assembly 300 can assist with uniform and/or widespread application of liquid during operation of spray assembly 300.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A spray assembly for a dishwasher appliance, the spray assembly defining an axial direction, a radial direction and a circumferential direction, the spray assembly comprising:
a housing having an annular sidewall and a base plate, the annular sidewall and the base plate mounted to each other and defining a chamber, the annular sidewall also defining a plurality of openings, the plurality of openings spaced apart from each other along the circumferential direction on the annular sidewall;
an impeller disposed within the chamber of the housing, the impeller being rotatable about an axis of rotation within the chamber of the housing, the impeller having a central portion and an outer portion that are spaced apart from each other along the radial direction, the impeller defining a plurality of conduits, each conduit of the plurality of conduits extending between an entrance and an exit, the entrance of each conduit of the plurality of conduits positioned adjacent the central portion of the impeller, the exit of each conduit of the plurality of conduits positioned at the outer portion of the impeller, a first exit of the plurality of conduits having a first height along the axial direction, a second exit of the plurality of conduits having a second height along the axial direction, the first height being different than the second height.

2. The spray assembly of claim 1, wherein each conduit of the plurality of conduits defines an arcuate shape in a plane that is perpendicular to the axial direction from about the entrance to the exit of each conduit of the plurality of conduits.

3. The spray assembly of claim 1, wherein the first exit of the plurality of conduits has a first width along the circumferential direction, the second exit of the plurality of conduits having a second width along the circumferential direction, the first width being different than the second width.

4. The spray assembly of claim 1, wherein each conduit of the plurality of conduits has a bottom surface, the bottom surface of each conduit of the plurality of conduits extending downwardly between about the entrance of each conduit of the plurality of conduits and the exit of each conduit of the plurality of conduits.

5. The spray assembly of claim 1, wherein the impeller includes a diverter cone positioned at the central portion of the impeller, a flow of liquid along the axial direction impacting the diverter cone during operation of the dishwasher appliance such that the flow of liquid is at least partially directed along the radial direction by the diverter cone.

6. The spray assembly of claim 1, wherein the impeller has a top surface and a bottom surface spaced apart from each other along the axial direction, the plurality of conduits positioned adjacent the top surface of the impeller, the impeller having a plurality of blades extending along the axial direction from the bottom surface of the impeller, the plurality of blades spaced apart from each other along the circumferential direction.

7. The spray assembly of claim 1, wherein the impeller extends between a top portion and a bottom portion, the top and bottom portions of the impeller spaced apart from each other along the axial direction, the plurality of conduits positioned at the top portion of the impeller, the impeller defining a cavity at the bottom portion of the impeller, the housing having a pivot mounted to the base plate of the housing, the pivot of the housing received within the cavity of the impeller in order to rotatably mount the impeller to the housing

8. The spray assembly of claim 1, wherein a number of conduits of the plurality of conduits is less than a number of openings of the plurality of openings.

9. The spray assembly of claim 8, wherein the plurality of conduits comprises at least three conduits and the plurality of openings comprises at least four openings.

10. The spray assembly of claim 1, wherein the plurality of conduits are configured for directing flows of liquid from the inner portion of the impeller to the outer portion of the impeller, the outer portion of the impeller positioned at the annular sidewall of the housing such that flows of liquid exit the chamber of the housing through the plurality of openings.

11. A spray assembly for a dishwasher appliance, the spray assembly defining an axial direction, a radial direction and a circumferential direction, the spray assembly comprising:
a housing having an annular sidewall and a base plate, the annular sidewall and the base plate mounted to each other and defining a chamber, the annular sidewall also defining a plurality of openings, the plurality of openings spaced apart from each other along the circumferential direction on the annular sidewall;
an impeller disposed within the chamber of the housing, the impeller being rotatable about an axis of rotation within the chamber of the housing, the impeller having a central portion and an outer portion that are spaced apart from each other along the radial direction, the impeller defining a plurality of conduits, each conduit of the plurality of conduits extending between an entrance and an exit, the entrance of each conduit of the plurality of conduits positioned adjacent the central portion of the impeller, the exit of each conduit of the plurality of conduits positioned at the outer portion of the impeller, a first exit of the plurality of conduits having a first width along the circumferential direction, a second exit of the plurality of conduits having a second width along the circumferential direction, the first width being different than the second width.

12. The spray assembly of claim 11, wherein each conduit of the plurality of conduits defines an arcuate shape in a plane that is perpendicular to the axial direction from about the entrance to the exit of each conduit of the plurality of conduits.

13. The spray assembly of claim 11, wherein the first exit of the plurality of conduits has a first height along the axial direction, the second exit of the plurality of conduits having a second height along the axial direction, the first height being different than the second height.

14. The spray assembly of claim 11, wherein each conduit of the plurality of conduits has a bottom surface, the bottom surface of each conduit of the plurality of conduits extending downwardly between about the entrance of each conduit of the plurality of conduits and the exit of each conduit of the plurality of conduits.

15. The spray assembly of claim 11, wherein the impeller includes a diverter cone positioned at the central portion of the impeller, a flow of liquid along the axial direction impacting the diverter cone during operation of the dishwasher appliance such that the flow of liquid is at least partially redirected along the radial direction by the diverter cone.

16. The spray assembly of claim 11, wherein the impeller has a top surface and a bottom surface spaced apart from each other along the axial direction, the plurality of conduits positioned adjacent the top surface of the impeller, the impeller having a plurality of blades extending along the axial direction from the bottom surface of the impeller, the plurality of blades spaced apart from each other along the circumferential direction.

17. The spray assembly of claim 11, wherein the impeller extends between a top portion and a bottom portion, the top and bottom portions of the impeller spaced apart from each other along the axial direction, the plurality of conduits positioned at the top portion of the impeller, the impeller defining a cavity at the bottom portion of the impeller, the housing having a pivot mounted to the base plate of the housing, the pivot of the housing received within the cavity of the impeller in order to rotatably mount the impeller to the housing.

18. The spray assembly of claim 11, wherein a number of conduits of the plurality of conduits is less than a number of openings of the plurality of openings.

19. The spray assembly of claim 18, wherein the plurality of conduits comprises at least three conduits and the plurality of openings comprises at least four openings.

20. The spray assembly of claim 11, wherein the plurality of conduits are configured for directing flows of liquid from the inner portion of the impeller to the outer portion of the impeller, the outer portion of the impeller positioned at the annular sidewall of the housing such that flows of liquid exit the chamber of the housing through the plurality of openings.
